(19) United States
(12) Patent Application Publication
(10) Pub. No.: US 2026/0338076 A1
(43) Pub. Date: Oct. 29, 2026

(54) PITCH CHANGE MECHANISM FOR AN AIRCRAFT ENGINE

(71) Applicant: GE Aerospace Poland Sp. z o.o., Warsaw (PL)

(72) Inventor: Miroslaw Sobaniec, Warsaw (PL)

(21) Appl. No.: 19/303,766

(22) Filed: Aug. 19, 2025

(30) Foreign Application Priority Data
Apr. 25, 2025 (PL) P.451879

(51) Int. Cl. F01D 7/00

(52) U.S. Cl. CPC F01D 7/00; F05D 2220/323; F05D 2220/36; F05D 2260/74

(57) ABSTRACT

A gas turbine engine includes a turbomachine with a compressor section, a combustion section, and a turbine section arranged in serial flow order. A fan includes a plurality of fan blades rotatable about a fan axis, and a pitch change mechanism to control a pitch of the fan blades. The pitch change mechanism includes an actuator having an actuator cylinder and an actuator piston axially movable within the actuator cylinder. The actuator cylinder defines forward and aft slider supports spaced axially apart from each other where the actuator piston is located between the forward and aft slider supports. A yoke shaft is coupled to the actuator piston and a fan blade. The yoke shaft is slidably supported by the forward and aft slider supports of the actuator cylinder where the forward and aft slider supports are positioned axially forward of the respective pitch axis of the fan blade.

### PRIORITY INFORMATION

The present application claims priority to Polish Patent Application Number P. 451879 filed on Apr. 25, 2025.

### TECHNICAL FIELD

The present disclosure generally relates to a pitch change mechanism for an aircraft engine.

### BACKGROUND

An aircraft engine may include a fan and a core arranged in flow communication with one another. Additionally, the core of the gas turbine engine generally includes, in serial flow order, a compressor section, a combustion section, a turbine section, and an exhaust section. The compressor section, combustion section, and turbine section together define a core air flowpath therethrough. In particular configurations, the turbine section is mechanically coupled to the compressor section by one or more shafts extending along an axial direction of the gas turbine engine. The fan includes a plurality of blades having a radius larger than the core of the gas turbine engine. The fan and plurality of blades may also be mechanically coupled to one of the one or more shafts such that they rotate along with the turbine. Rotation of the plurality of blades generates thrust for the gas turbine engine and provides airflow to the compressor section of the core. For at least some aircraft engines, the fan is a variable pitch fan. It can be desirable to vary a pitch of the fan blades by rotating the blades about respective pitch axes to further increase performance of the aircraft engine. For example, a primary reason for changing blade pitch is to adjust the blade's angle of attack for optimal performance based on the present air speed of the aircraft and power level of the engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine according to the present disclosure.

FIG. 2 is a schematic cross-sectional view of a portion of a fan section of the gas turbine engine depicted in FIG. 1 according to the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

The terms “coupled,” “fixed,” “attached to,” and the like refer to both direct coupling, fixing, or attaching, as well as indirect coupling, fixing, or attaching through one or more intermediate components or features, unless otherwise specified herein.

The term “proximate” refers to being closer to one end than an opposite end. For example, when used in conjunction with first and second ends; high pressure and low pressure sides; or the like, the phrase “proximate the first end,” or “proximate the high pressure side,” refers to a location closer to the first end than the second end, or closer to the high pressure side than the low pressure side, respectively.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

A “third stream” as used herein means a non-primary air stream capable of increasing fluid energy to produce a minority of total propulsion system thrust. The third stream may generally receive inlet air (air from a ducted passage downstream of a primary fan) instead of freestream air (as the primary fan would). A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The present disclosure is generally related to a pitch change mechanism for a fan of an aircraft engine such as, by way of non-limiting example, a gas turbine engine. The pitch change mechanism includes a yoke shaft that is axially translatable to rotate a fan blade of the fan about its respective pitch axis. In exemplary embodiments, the yoke shaft is supported from a single side of the fan blade to reduce weight and/or free up space within the gas turbine engine for other components of the aircraft engine. Thus, embodiments of the present disclosure also enable a more compact aircraft engine. In exemplary embodiments, the yoke shaft is supported from the forward side of the fan blade and creates an open area aft of the fan blade to accommodate other aircraft engine components.

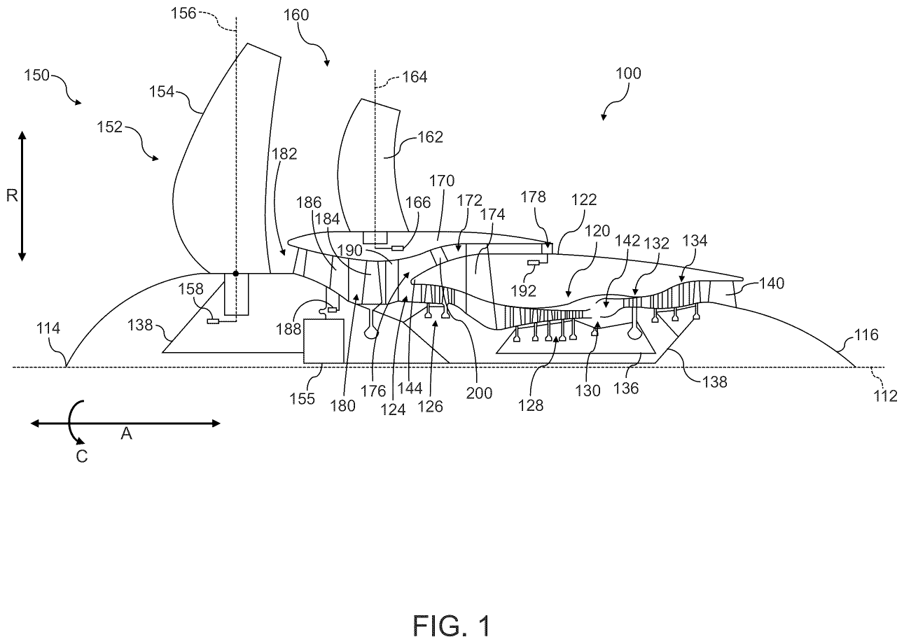

Referring now to FIG. 1, a schematic cross-sectional view of an engine 100 for an aircraft is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from the compressor section to a rotor assembly flowpath over the turbomachine, as will be explained in more detail below. The engine 100 may also be referred to as a gas turbine engine.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112, sometimes referred to as the fan axis. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade or pitch axis 156. For this embodiment, each fan blade 154 of the fan 152 is rotatable about its pitch axis 156, e.g., in unison with one another. One or more actuators 158 are provided to facilitate such rotation and therefore may be used to change a pitch of the fan blades 154 about their respective pitch axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through the fan duct 172 as a heat sink and correspondingly increases the temperature of the air downstream of the heat exchanger 200 and exiting the fan exhaust nozzle 178.

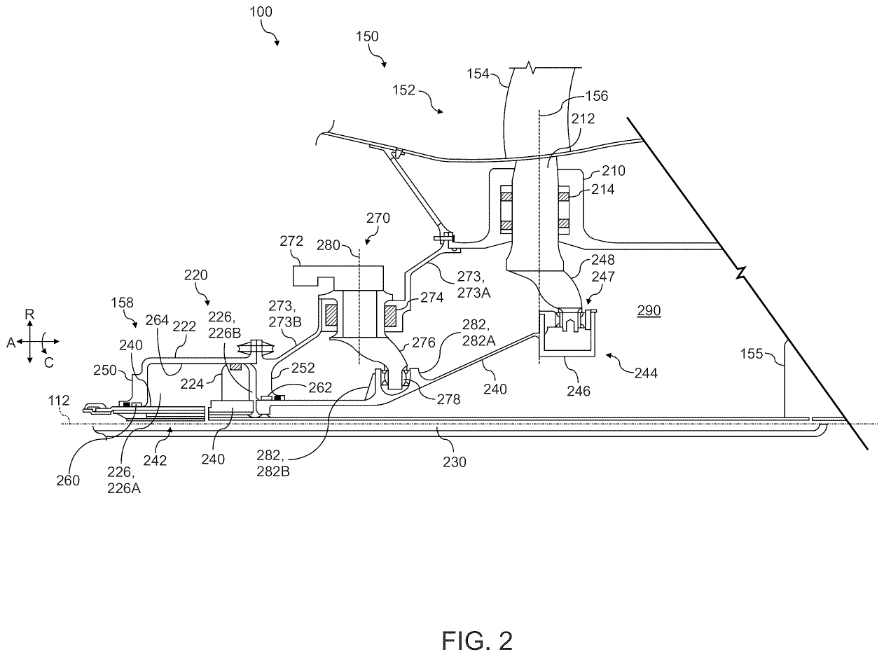

FIG. 2 depicts a schematic cross-sectional view of a portion of the fan section 150 of the engine 100. In the illustrated embodiment, the fan 152 generally includes a variable pitch fan 152 having a plurality of the fan blades 154 coupled to a disk 210. More specifically, each fan blade 154 has its radially inward end coupled to the disk 210 via a respective trunnion mechanism 212. The disk 210 may include a plurality of bearings 214 such that the trunnion mechanism 212 is rotatably mounted within the disk 210 such that the trunnion mechanism 212 facilitates rotation of a respective fan blade 154 about a respective pitch axis 156 of the respective fan blade 154. Furthermore, as will be discussed in greater detail below, the exemplary engine 100 depicted includes a pitch change mechanism 220 operable with the plurality of fan blades 154 for rotating the plurality of fan blades 154 about their respective pitch axes 156.

In exemplary embodiments, the pitch change mechanism 220 includes the actuator 158. The actuator 158 may include an actuator cylinder 222 and an actuator piston 224 disposed within the actuator cylinder 222. The actuator cylinder 222 defines one or more chambers 226 for containing a pressurized fluid. In the illustrated embodiment, the one or more chambers 226 includes a forward chamber 226A and an aft chamber 226B separated by the actuator piston 224. The forward chamber 226A is located on the forward-facing side of the actuator piston 224, and the aft chamber 226B is located on the aft-facing side of the actuator piston 224. The actuator piston 224 is movable or translatable in an axial direction based on a pressure differential of the pressurized fluid contained within the forward and aft chambers 226A, 226B. The forward chamber 226A may be considered the coarse pitch side of the actuator piston 224, and the aft chamber 226B may be considered the fine pitch side of the actuator piston 224. The actuator cylinder 222 and/or the actuator piston 224 may be annular structures extending in the circumferential direction C or may be located at discrete circumferential locations.

The actuator piston 224 is attached to the yoke shaft 240 and translates axially forward and aft as fluid pressure is metered to the coarse and fine pitch sides of the actuator piston 224. Thus, pressure differential of the fluid in the forward chamber 226A and the aft chamber 226B acts across the actuator piston 224 to generate the force to move the actuator piston 224 forward and/or aft to change the pitch of the fan blade 154. One or more fluid supply lines 230 may be in flow communication with each of the one or more chambers 226 and a pressurized fluid source such as, by way of non-limiting example, the speed reduction gearbox 155.

In the illustrated embodiment, the pitch change mechanism 220 also includes a yoke shaft 240. The yoke shaft 240 is coupled to the actuator piston 224 and translates axially forward and aft based on movement of the actuator piston 224 due to the pressure differential of the fluid within the forward and aft chambers 226A, 226B. The yoke shaft defines a forward end 242 and an aft end 244 opposite the forward end 242. The forward end 242 is coupled to the actuator piston 224. The aft end 244 includes a yoke 246 coupled to a respective fan blade 154 via one or more bearing assemblies 247 and a crank arm 248. The crank arm 248 may be part of the trunnion mechanism 212 and extends radially inward. The yoke 246 rotatably connects the aft end 244 of the yoke shaft 240 to the crank arm 248 via the one or more bearing assemblies 247. The connection location of the yoke 246 to the crank arm 248 is offset from the pitch axis 156 such that linear motion of the yoke shaft 240 is converted to rotation of the respective fan blade 154 about its respective pitch axis 156.

In exemplary embodiments, the actuator cylinder 222 defines a forward slider support 250 and an aft slider support 252. The aft slider support 252 is spaced apart axially aft of the forward slider support 250. In the illustrated embodiment of FIG. 2, the forward and aft slider supports 250, 252 are located radially outward from the yoke shaft 240 and provide a slidable interface of the yoke shaft 240 with the actuator cylinder 222. In other words, the forward and aft slider supports 250, 252 are located radially outward from the forward end 242 of the yoke shaft 240. In exemplary embodiments, the forward slider support 250 defines a forward bearing assembly 260, and the aft slider support 252 defines an aft bearing assembly 262. The forward and aft bearing assemblies 260, 262 provide axial slidable or translatable engagement of the yoke shaft 240 with respect to the actuator cylinder 222. The forward and aft bearing assemblies 260, 262 may each include a group of components for enabling relative rotation between two or more components. In the embodiment illustrated in FIG. 2, the actuator piston 224 is axially translatable within the actuator cylinder 222 between the forward and aft slider supports 250, 252. In exemplary embodiments, the actuator piston 224 is connected to the yoke shaft 240 at its radially inward portion and translatably engages a radially outward sidewall 264 of the actuator cylinder 222 at its radially outward portion. Axial movement of the actuator piston 224 within the actuator cylinder 222 may encompass the span between the forward and aft slider supports 250, 252 or may encompass less than the span between the forward and aft slider supports 250, 252.

In the embodiment depicted in FIG. 2, the forward end 242 of the yoke shaft 240 is supported by the forward and aft slider supports 250, 252. The yoke shaft 240 extends aft of the actuator 158 (e.g., aft of the aft slider support 252) and transitions radially outward to engage the respective fan blade 154. In the embodiment illustrated in FIG. 2, the yoke shaft 240 is rotatably coupled to a counterweight system 270. The counterweight system 270 may include one or more counterweights 272 configured to affect a position of the fan blades 154. In exemplary embodiments, the one or more counterweights 272 are employed to bias the fan blade 154 to a high pitch or feathered condition in the event of a pressurized fluid system failure. The one or more counterweights 272 produce a twisting moment on the fan blade 154 when the fan blade 154 is rotating such that the twisting moment on the fan blade 154 bias the fan blade 154 to the high pitch or feathered condition. In the embodiment depicted in FIG. 2, the counterweight system 270 includes one or more supports 273 rotatably supporting the one or more counterweights 272 via one or more bearing assemblies 274. In the embodiment illustrated in FIG. 2, the one or more supports 273 include one or more aft supports 273A and one or more forward supports 273B. The one or more aft supports 273A may be coupled to the disk 210 and/or other support structure of the engine 100. The one or more forward supports 273B may be coupled to the aft slider support 252 and/or other support structure of the engine 100. The one or more bearings assemblies 274 enable rotatable movement of the one or more counterweights 272 about a rotational axis 280. The counterweight system 270 also includes a crank arm 276 rotatably coupled to the yoke shaft 240 via one or more bearing assemblies 278. In the embodiment illustrated in FIG. 2, the yoke shaft 240 includes one or more support arms 282 extending radially outward toward the crank arm 276 and rotationally engaging the crank arm 276 via the one or more bearings assemblies 278. In the embodiment depicted in FIG. 2, the yoke shaft 240 includes an aft support arm 282A and a forward support arm 282B each rotationally engaging the crank arm 276 via the one or more bearings assemblies 278. In exemplary embodiments, the counterweight system 270 is rotatably coupled to the yoke shaft 240 between the forward end 242 and the aft end 244 of the yoke shaft 240. In other words, the one or more support arms 282 coupling the yoke shaft 240 to the counterweight system 270 are located between the forward end 242 and the aft end 244 of the yoke shaft 240. In the embodiment depicted in FIG. 2, the connection location of the yoke shaft 240 to the crank arm 276 is offset from the rotational axis 280 such that linear motion of the yoke shaft 240 is converted to rotation of the respective counterweight 272 about its respective rotational axis 280.

In the embodiment depicted in FIG. 2, the aft end 244 of the yoke shaft 240 is unsupported at locations axially aft of its connection to the crank arm 248. In other words, in exemplary embodiments, the aft end 244 of the yoke shaft 240 is unsupported at locations axially aft of the respective fan blade 154. Thus, in exemplary embodiments, translational movement of the yoke shaft 240 in the axial direction A is supported solely by the forward and aft slider supports 250, 252. As depicted in FIG. 2, the forward and aft slider supports 250, 252 are located forward of the counterweight system 270. In exemplary embodiments, the forward and aft slider supports 250, 252 are located forward of the pitch axis 156 of the respective fan blade 154. Thus, translational movement of the yoke shaft 240 in the axial direction A is supported solely by the forward and aft slider supports 250, 252 that are located forward of the fan blade 154. Accordingly, in exemplary embodiments, translational movement of the yoke shaft 240 in the axial direction A is supported solely by the actuator 158, and the actuator 158 is located forward of the counterweight system 270. At least because the aft end 244 of the yoke shaft 240 is unsupported at locations axially aft of its connection to the crank arm 248, additional support structure located aft of the aft end 244 of the yoke shaft 240 is unnecessary and creates an available space or void area 290 aft and radially inward of the aft end 244 of the yoke shaft 240. The creation of the void area 290 reduces the weight of the engine 100 at least based on the lack of support structure for the yoke shaft 240 aft of its connection to the crank arm 248 and enables placement of other components of the engine 100 within the void area 290 resulting in a more compact engine 100. Accordingly, instead of a straddle-based support structure where a yoke shaft may be supported forward and aft of the respective fan blade, embodiments of the present disclosure provide a single-sided support for the yoke shaft 240 located forward of the respective fan blade 154 while the aft end 244 of the yoke shaft 240 overhangs or projects aft from the actuator 158 and is unsupported aft of the respective fan blade 154.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the disclosure are provided by the subject matter of the following clauses:

A gas turbine engine, comprising: a turbomachine comprising a compressor section, a combustion section, and a turbine section arranged in serial flow order; a fan defining a fan axis and comprising a plurality of fan blades rotatable about the fan axis; a pitch change mechanism operable with the plurality of fan blades to control a pitch of the plurality of fan blades about a respective one of a plurality of pitch axes, wherein the pitch change mechanism comprises: an actuator comprising an actuator cylinder and an actuator piston disposed within the actuator cylinder and axially movable within the actuator cylinder, the actuator cylinder defining a forward slider support and an aft slider support, the aft slider support spaced axially apart and aft from the forward slider support, and wherein the actuator piston is located between the forward and aft slider supports; and a yoke shaft coupled to the actuator piston and a first fan blade of the plurality of fan blades, the yoke shaft slidably supported by the forward and aft slider supports of the actuator cylinder, and wherein the forward and aft slider supports of the actuator cylinder are positioned axially forward of the respective pitch axis of the first fan blade.

The gas turbine engine of the previous clause, wherein the forward and aft slider supports of the actuator cylinder are positioned axially forward of the first fan blade.

The gas turbine engine of any previous clause, wherein the yoke shaft is coupled to a counterweight system configured to affect the pitch of the first fan blade.

The gas turbine engine of any previous clause, wherein the forward and aft slider supports of the actuator cylinder are positioned axially forward of the counterweight system.

The gas turbine engine of any previous clause, wherein the yoke shaft is defined by a forward end and an aft end opposite the forward end, wherein the forward end is slidably coupled to the actuator cylinder, and wherein the aft end is coupled to the first fan blade, and wherein the aft end is unsupported aft of the first fan blade.

The gas turbine engine of any previous clause, further comprising a counterweight system coupled to the yoke shaft between the forward end and the aft end.

The gas turbine engine of any previous clause, wherein the forward slider support comprises a forward bearing assembly, and wherein the aft slider support comprises an aft bearing assembly.

The gas turbine engine of any previous clause, wherein the forward and aft slider supports are located forward of the pitch axis of the first fan blade.

The gas turbine engine of any previous clause, wherein the yoke shaft defines a forward end and an aft end, wherein the aft end is coupled to the first fan blade via a crank arm, and wherein the aft end of the yoke shaft is unsupported axially aft of a connection of the aft end to the crank arm.

The gas turbine engine of any previous clause, wherein the yoke shaft extends aft of the aft slider support and transitions radially outward to engage the first fan blade.

The gas turbine engine of any previous clause, wherein the actuator piston is axially translatable within the actuator cylinder between the forward and aft slider supports.

The gas turbine engine of any previous clause, wherein the yoke shaft defines a forward end and an aft end, wherein the forward end is coupled to the actuator piston, and wherein the aft end 244 comprises a yoke coupled to the first fan blade.

A gas turbine engine, comprising: a turbomachine having a compressor section, a combustion section, and a turbine section in serial flow order; a fan defining a fan axis and comprising a plurality of fan blades rotatable about the fan axis; and a pitch change mechanism operable with the plurality of fan blades to control a pitch of the plurality of fan blades about a respective one of a plurality of pitch axes, wherein the pitch change mechanism comprises: an actuator defining a forward slider support and an aft slider support, the aft slider support spaced axially apart and aft from the forward slider support, the actuator comprising an actuator piston axially translatable between the forward and aft slider supports; and a yoke shaft defining a forward end and an aft end, the forward end slidably coupled to the actuator piston and supported by the forward and aft slider supports of the actuator, the aft end coupled to a first fan blade of the plurality of fan blades, wherein the yoke shaft is unsupported aft of the aft end of the yoke shaft.

The gas turbine engine of any previous clause, wherein the forward and aft slider supports of the actuator are positioned axially forward of the first fan blade.

The gas turbine engine of any previous clause, wherein the yoke shaft is coupled to a counterweight system configured to affect the pitch of the first fan blade.

The gas turbine engine of any previous clause, wherein the counterweight system is coupled to the yoke shaft between the forward end and the aft end.

The gas turbine engine of any previous clause, wherein the forward and aft slider supports of the actuator each comprise one or more bearing assemblies.

The gas turbine engine of any previous clause, further comprising one or more fluid supply lines coupled in flow communication with the actuator and configured to transfer a flow of a pressurized fluid to the actuator.

The gas turbine engine of any previous clause, wherein the actuator comprises an actuator cylinder defining the forward and aft slider supports of the actuator.

A gas turbine engine, comprising: a turbomachine having a compressor section, a combustion section, and a turbine section in serial flow order; a fan defining a fan axis and comprising a plurality of fan blades rotatable about the fan axis; and a pitch change mechanism operable with the plurality of fan blades to control a pitch of the plurality of fan blades about a respective one of a plurality of pitch axes, wherein the pitch change mechanism comprises: an actuator defining a forward slider support and an aft slider support, the aft slider support disposed spaced apart and aft of the forward slider support, the actuator comprising an actuator piston axially translatable between the forward and aft slider supports; a yoke shaft coupled to a first fan blade of the plurality of fan blades and slidably supported by the forward and aft slider supports of the actuator; and a counterweight system coupled to the yoke shaft and configured to affect the pitch of the first fan blade.

The gas turbine engine of any previous clause, wherein the yoke shaft is defined by a forward end and an aft end opposite the forward end, wherein the forward end is slidably supported by the forward and aft slider supports of the actuator, and wherein the aft end is coupled to the first fan blade.

The gas turbine engine of any previous clause, wherein the aft end is unsupported aft of the first fan blade.

The gas turbine engine of any previous clause, wherein the counterweight system is coupled to the yoke shaft between the forward end and the aft end.

The gas turbine engine of any previous clause, further comprising one or more fluid supply lines coupled in flow communication with the actuator and configured to transfer a flow of a pressurized fluid to the actuator.

The gas turbine engine of any previous clause, wherein the forward and aft slider supports of the actuator are positioned radially outward of the yoke shaft.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A gas turbine engine, comprising:
a turbomachine comprising a compressor section, a combustion section, and a turbine section arranged in serial flow order;
a fan defining a fan axis and comprising a plurality of fan blades rotatable about the fan axis;
a pitch change mechanism operable with the plurality of fan blades to control a pitch of the plurality of fan blades about a respective one of a plurality of pitch axes, wherein the pitch change mechanism comprises:
an actuator comprising an actuator cylinder and an actuator piston disposed within the actuator cylinder and axially movable within the actuator cylinder, the actuator cylinder defining a forward slider support and an aft slider support, the aft slider support spaced axially apart and aft from the forward slider support, and wherein the actuator piston is located between the forward and aft slider supports; and
a yoke shaft coupled to the actuator piston and a first fan blade of the plurality of fan blades, the yoke shaft slidably supported by the forward and aft slider supports of the actuator cylinder, and wherein the forward and aft slider supports of the actuator cylinder are positioned axially forward of the respective pitch axis of the first fan blade, and wherein the yoke shaft is cantilever supported by the forward and aft slider supports.

2. The gas turbine engine of claim 1, wherein the forward and aft slider supports of the actuator cylinder are positioned axially forward of the first fan blade.

3. The gas turbine engine of claim 1, wherein the yoke shaft is coupled to a counterweight system configured to affect the pitch of the first fan blade.

4. The gas turbine engine of claim 3, wherein the forward and aft slider supports of the actuator cylinder are positioned axially forward of the counterweight system.

5. The gas turbine engine of claim 1, wherein the yoke shaft is defined by a forward end and an aft end opposite the forward end, wherein the forward end is slidably coupled to the actuator cylinder, and wherein the aft end is coupled to the first fan blade, and wherein the aft end is unsupported aft of the first fan blade.

6. The gas turbine engine of claim 5, further comprising a counterweight system coupled to the yoke shaft between the forward end and the aft end.

7. The gas turbine engine of claim 1, wherein the forward slider support comprises a forward bearing assembly, and wherein the aft slider support comprises an aft bearing assembly.

8. A gas turbine engine, comprising:
a turbomachine having a compressor section, a combustion section, and a turbine section in serial flow order;
a fan defining a fan axis and comprising a plurality of fan blades rotatable about the fan axis; and
a pitch change mechanism operable with the plurality of fan blades to control a pitch of the plurality of fan blades about a respective one of a plurality of pitch axes, wherein the pitch change mechanism comprises:
an actuator defining a forward slider support and an aft slider support, the aft slider support spaced axially apart and aft from the forward slider support, the actuator comprising an actuator piston axially translatable between the forward and aft slider supports; and
a yoke shaft defining a forward end and an aft end, the forward end slidably coupled to the actuator piston and supported by the forward and aft slider supports of the actuator, the aft end coupled to a first fan blade of the plurality of fan blades, wherein the yoke shaft is unsupported aft of the aft end of the yoke shaft, and wherein the yoke shaft is cantilever supported by the forward and aft slider supports.

9. The gas turbine engine of claim 8, wherein the forward and aft slider supports of the actuator are positioned axially forward of the first fan blade.

10. The gas turbine engine of claim 8, wherein the yoke shaft is coupled to a counterweight system configured to affect the pitch of the first fan blade.

11. The gas turbine engine of claim 10, wherein the counterweight system is coupled to the yoke shaft between the forward end and the aft end.

12. The gas turbine engine of claim 8, wherein the forward and aft slider supports of the actuator each comprise one or more bearing assemblies.

13. The gas turbine engine of claim 8, further comprising one or more fluid supply lines coupled in flow communication with the actuator and configured to transfer a flow of a pressurized fluid to the actuator.

14. The gas turbine engine of claim 8, wherein the actuator comprises an actuator cylinder defining the forward and aft slider supports of the actuator.

15. A gas turbine engine, comprising:
a turbomachine having a compressor section, a combustion section, and a turbine section in serial flow order;
a fan defining a fan axis and comprising a plurality of fan blades rotatable about the fan axis; and
a pitch change mechanism operable with the plurality of fan blades to control a pitch of the plurality of fan blades about a respective one of a plurality of pitch axes, wherein the pitch change mechanism comprises:
an actuator defining a forward slider support and an aft slider support, the aft slider support disposed spaced apart and aft of the forward slider support, the actuator comprising an actuator piston axially translatable between the forward and aft slider supports;
a yoke shaft coupled to a first fan blade of the plurality of fan blades and slidably supported by the forward and aft slider supports of the actuator; and
a counterweight system coupled to the yoke shaft and configured to affect the pitch of the first fan blade, and wherein the counterweight system is coupled to the yoke shaft between the forward end and the aft end.

16. The gas turbine engine of claim 15, wherein the yoke shaft is defined by a forward end and an aft end opposite the forward end, wherein the forward end is slidably supported by the forward and aft slider supports of the actuator, and wherein the aft end is coupled to the first fan blade.

17. The gas turbine engine of claim 16, wherein the aft end is unsupported aft of the first fan blade.

18. (canceled)

19. The gas turbine engine of claim 15, further comprising one or more fluid supply lines coupled in flow communication with the actuator and configured to transfer a flow of a pressurized fluid to the actuator.

20. The gas turbine engine of claim 15, wherein the forward and aft slider supports of the actuator are positioned radially outward of the yoke shaft.
